(19) United States
(12) Patent Application Publication
(10) Pub. No.: US 2026/0369056 A1
(43) Pub. Date: Nov. 19, 2026

(54) ARTIFICIAL INTELLIGENCE (AI) BASED VISION ANALYTICS WITH AI AUTOMATED CODE GENERATION

(71) Applicant: POLYTRON.AI PTE. LTD., SINGAPORE (SG)

(72) Inventor: Seng Fook LEE, SINGAPORE (SG)

(21) Appl. No.: 19/649,083

(22) Filed: Apr. 15, 2026

Related U.S. Application Data
(60) Provisional application No. 63/789,395, filed on Apr. 15, 2025.
(60) Provisional application No. 63/806,726, filed on May 16, 2025.

(51) Int. Cl. G06V 20/40; G06F 8/35

(52) U.S. Cl. CPC G06V 20/41; G06F 8/35

(57) ABSTRACT

A system and method are disclosed for enhancing a camera's capabilities by embedding digital intelligence that processes multi-modal data including video, audio, and contextual inputs. An intelligent processing module resides in or near the camera, analyzing the combined data to achieve higher-order semantic understanding. By leveraging advanced AI inference models, the invention enables context-aware monitoring, autonomous event detection, and adaptive learning. This approach significantly reduces the need for extensive manual data labelling or model retraining, transforming the camera from a passive sensor into an active agent capable of interpreting and reasoning about its environment.

### CROSS-REFERENCE

The present disclosure claims the benefit of U.S. Provisional Applications Ser. No. 63/789,395, filed on Apr. 15, 2025, and U.S. Provisional Applications Ser. No. 63/806,726, filed on May 16, 2025. All disclosures are herein incorporated by reference in their entireties for all purposes.

### FIELD OF THE INVENTION

The present disclosure relates generally to video analytics. In particular, the present disclosure relates to prompt-based vision analytics with automated code generation using multi-modal data and frontier AI models.

### BACKGROUND

Conventional camera surveillance systems primarily rely on convolutional neural networks (CNNs) to analyze video data at the pixel level. Such systems have proven effective at object detection and classification, particularly when large, well-curated datasets are available. In many industrial and commercial settings, CNNs are deployed alongside frameworks, such as “You Only Look Once” (YOLO) to detect and track objects of interest, such as people or vehicles, in real-time. Such conventional systems significantly streamlined the capability of cameras to identify discrete elements within a scene.

Convolutional Neural Networks (CNNs) and their derivatives, such as YOLO, form the backbone of conventional video analytics systems. Such conventional architectures process images as structured pixel arrays, applying convolutional filters to extract features from local regions within the image.

YOLO represents a family of one-stage object detection models that have evolved from YOLOv1 to YOLOv10, processing entire images in a single pass for real-time detection. As a one-stage detector, YOLO combines region proposal and classification into a single step, making it substantially faster than earlier two-stage detection models. The YOLO approach analyzes images through convolutional operations, creating feature maps of small image areas at a time to eventually build a complete scene understanding.

CNN-based approaches treat images hierarchically through convolution operations, building from simple features (edges, colors) in early layers to more complex patterns in deeper layers. This approach inherently focuses on local spatial relationships within defined receptive fields.

Despite these achievements, traditional CNN-based video analytics methods present substantial disadvantages. Foremost, they generally require extensive human-labelled training data, imposing considerable demands on data collection, curation, filtering, and preprocessing. Practitioners often spend a disproportionate amount of time assembling and cleaning datasets before any real analysis or application development can begin.

Moreover, implementing these systems requires robust programming knowledge in Python or similar languages and familiarity with computer vision libraries. These hurdles can inhibit scalability and restrict the technology's accessibility to a limited pool of highly skilled professionals.

A further limitation of current video analytics arises from their inability to interpret the deeper semantics of a scene. While CNNs can detect whether a person is present or if a car is moving, they lack higher-level reasoning and contextual understanding. Consequently, these systems cannot reliably identify behaviors, interactions, or intentions within their field of view. Additionally, CNN-based approaches are often rigid, with each task demanding specialized reprogramming and retraining, creating a static workflow that struggles to adapt to changing conditions or novel tasks.

Furthermore, building conventional computer vision systems, like video analytics, requires stitching together Python scripts, training or fine-tuning YOLO models, handling OpenCV pipelines, processing frames, drawing bounding boxes, and deploying models via Flask or FastAPI. This is time-consuming and prone to errors. In addition, building such systems requires deep domain expertise.

In particular, developing such systems requires manual coding with Python+YOLO. For example, a developer has to:
write boilerplate Python code for real-time video input;
integrate a YOLO model (e.g., YOLOv5 or YOLOv8);
handle model inference, FPS, NMS post-processing;
draw bounding boxes and labels with OpenCV; and
export logs or trigger events based on detections.
   While conventional systems are powerful, they, however, require a full stack of ML (Machine Learning) Engineering, Coding, and DevOps knowledge just to get a basic system running.

From the foregoing discussion, there is a desire to provide a solution for viewing large information 3D models in resource-constrained environments.

### SUMMARY

In one embodiment, a system for implementing digital intelligence in a camera device that leverages multi-modal data (including, but not limited to, video frames, audio signals, and contextual text) to achieve advanced scene comprehension and video understanding is provided. The system is embedded in the camera or a server, incorporating an intelligent processing unit for receiving various sensors and multi-modal inputs. By fusing video, audio, and potentially other sensor data, the system can interpret events, behaviors, and interactions at a semantic level, thus overcoming the limitations of purely pixel-focused CNN analytics. The system can be used for both live and offline video feeds. For example, live feeds can be analyzed in real time while existing feeds can be analyzed forensically by the system.

In another embodiment, a method is disclosed for continuously and autonomously analyzing camera or video feeds with minimal manual intervention. This method includes capturing multi-modal input, processing it through an integrated vision-language (and optionally audio) inference model, generating context-aware code and/or alerts, and self-adapting over time. The approach is designed to avoid extensive reprogramming or re-labelling whenever task requirements evolve. As a result, the invention can effectively shift a camera from a passive observer to an active intelligence layer.

Through this architecture, the embodiments enable these and other objectives, along with advantages and features of the present embodiments herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present disclosure are described with reference to the following drawings, in which:

FIG. 1 shows a simplified block diagram of an embodiment of a vision analytics system;

FIG. 2 shows an embodiment of a high-level system architecture of a code editor;

FIG. 3 shows an embodiment of a simplified multi-model input code engine;

FIG. 4 shows a simplified block diagram of an embodiment of a digital intelligence system for a sensor or camera;

FIG. 5 shows a simplified block diagram of an embodiment of a digital intelligence system residing in a server;

FIGS. 6a-6b show an exemplary user interface of a digital intelligence system;

FIGS. 7a-7f show different examples of applications of a digital intelligence system;

FIGS. 8a-8c show an embodiment of a live 3D mapping and analytics system;

FIGS. 9a-9b show an embodiment of an architecture of a live 3D mapping and analytics system;

FIGS. 10a-10d show different examples of general applications of a live 3D mapping and analytics system; and

FIGS. 11a-11b show different examples of digital surveillance applications of a live 3D mapping and analytics system.

### DETAILED DESCRIPTION

Embodiments described herein generally relate to systems and methods for video analytics. In one embodiment, the vision analytics system includes an automated prompt-driven code generator. The automated code generation, in one embodiment, includes a prompt-driven code generator using multimodal data and frontier AI models. The workflow of the systems and methods includes receiving a prompt, the AI analyzes the prompt and generates coded video analytics automatically based on the prompt to provide a working video analytics system.

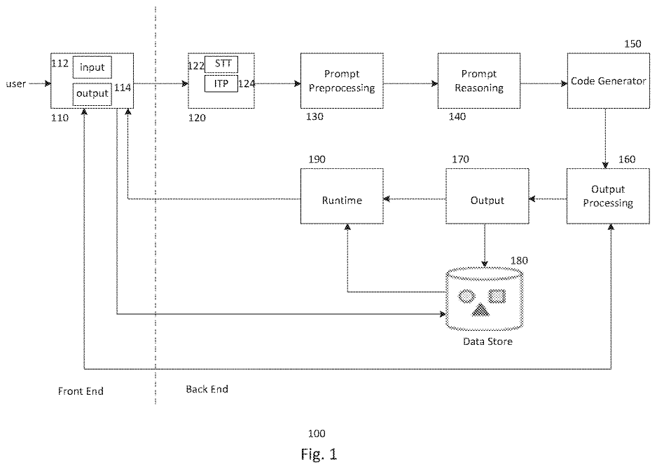

FIG. 1 shows a simplified block diagram of an embodiment of a video analytics system 100. The system includes an input/output (I/O) module 110, a multi-modal input processing module 120, a prompt preprocessing module 130, a prompt reasoning module 140, a code generator module 150, an output processing module 160, an output module 170, a data store module 180 and a runtime module 190. Providing the system with other modules may also be useful.

The I/O module includes an input unit 112 and an output unit 114. The input unit is configured to receive multi-modal inputs from a user. The input unit can include various types of input devices, such as a smart phone, a laptop computer, a keyboard, a mouse, a microphone, a display, a camera, as well as other input devices or a combination of devices, enabling a user to communicate with the system. The display can be a touch-sensitive display. As for the output device, it can include a smart phone, a laptop computer, a display, a speaker. as well as other types of output devices or a combination of devices, enabling the system to communicate with the user. It is understood that input and output devices can be the same devices, different devices or a combination thereof.

A multi-modal input may include a text input, a voice input, image/video snapshots or a sketch or drawing on a user interface. Other types of multi-modal input may also be useful. For text input, as an example, may be input to the system via a keyboard. Other techniques for inputting text input may also be useful. An example of a text input may be a descriptive prompt, such as “track vehicles and count how many passes through the toll booth”. Text prompts for other purposes may also be useful. For voice input, the user may speak naturally using, for example, a microphone. An example of a voice prompt may be “Alert me if a person stays longer than 30 seconds near the exit”. Voice prompts for other purposes may also be useful.

In the case of an image (including a video snapshot) input, it can be uploaded to the system using, for example, a camera, scanner or as an image document. Other techniques for uploading the image may also be useful. The image can be highlighted to indicate the area of interest. In another embodiment, the multi-modal input may be a sketch or document created on an application or the user interface. For example, a flow diagram can be created using a drawing application that describes a topic of interest, such as analytics logic.

The multi-modal input processing module is configured to process the multi-modal input and convert it to text. No processing is necessary for text input. In one embodiment, the multi-modal input processing module includes a speech-to-text (STT) unit 122 and an image-to-prompt (ITP) unit 124. The STT unit converts a speech input to a text prompt. The STT unit may be employed, for example, Whisper. Other models for converting speech-to-text to generate the text prompt may also be useful. The ITP unit converts an image or document input to a text prompt.

The prompt preprocessing module is configured to process the text prompt from the multi-modal input processing module. In one embodiment, the prompt preprocessing module encodes the text prompt. For example, tokenization and sentence chunking may be employed to encode the text prompt. Encoding the text prompt enables models to map semantic meaning into a geometric space, where the distance between vectors represents the relationship between words.

The encoded text prompt is passed to the prompt reasoning module for processing. The prompt reasoning module includes large language models (LLMs), including Frontier Models, for analyzing the encoded text prompt. For example, the prompt reasoning module may employ Whisper, +ChatGPT or Gemini 1.5. Other types of LLMs may also be useful.

The reasoned prompt from the prompt reasoning module is used by the code generator module for automatic code generation. For example, the code is based on the reasoned prompt, enabling the vision analytic system to perform the desired function or task. In one embodiment, the code generator includes pre-trained vision models. For example, the coder generator includes pre-trained vision models, such as YOLOv8 and SAM. Other types of pre-trained vision models may also be useful. The pre-trained vision models are used for automatic code generation.

In one embodiment, the pre-trained vision models are auto-wrapped. For example, the pre-trained vision models are wrapped with learnable prompts or modules to adapt them for new tasks. For example, pre-trained vision models serve as prompt-to-code LLMs fine-tuned on video analytics libraries. Auto-wrapping may include, for example, visual prompt tuning (VPT), adapter tuning, scene objects from transformers (SOFT), or visual prefix tuning. Other auto-wrapping techniques may also be useful.

The code from the code generator (code generator output) is processed by the output processing module. In one embodiment, the output processing module includes in-browser execution of a cloud-based sandbox to preview the results. For example, the user can preview the code, ensuring that it performs the task properly. The code is validated if it performs the task properly.

The validated code is provided to the output module. The output module stores the validated code in the data store module 180. The data store module may include other validated codes for performing other tasks. In addition, the validated code is passed to the runtime environment. For example, the validated code runs in the virtual environment.

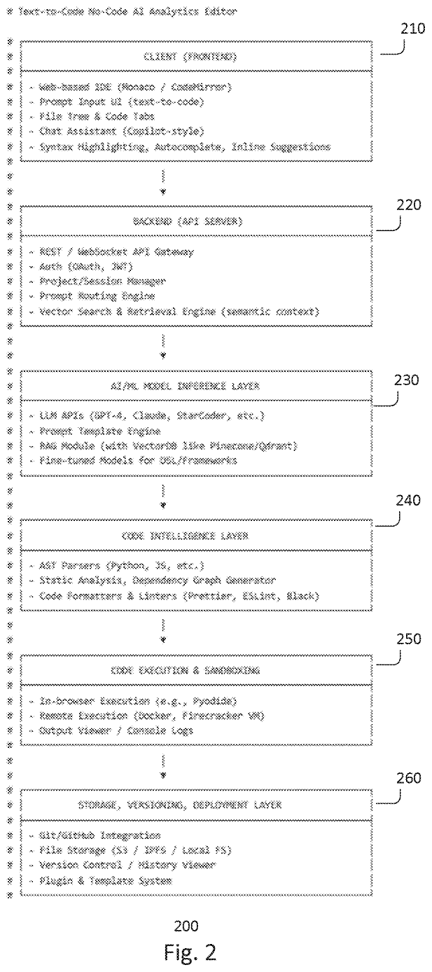

FIG. 2 shows an embodiment of a high-level system architecture 200 of an AI analytics editor configured to translate natural language inputs into executable code within a no-code or low-code analytics environment. The system includes a client (frontend) layer 210 a backend (API server) layer 220, an artificial intelligence/machine learning (AI/ML) model inference layer 230, a code intelligence layer 240, a code execution and sandboxing layer 250, and a storage, versioning, and deployment layer 260.

Directional arrows represent communication and data flow between the respective layers of the system architecture. For example, the client layer sends natural language input to the backend layer for processing and routing, the backend layer forwards the input to the AI/ML model inference layer for generating code outputs, the generated code is provided to the code intelligence layer for analysis and refinement, the refined code is executed within the code execution and sandboxing layer, and the resulting code artifacts are stored, versioned, and optionally deployed via the storage, versioning, and deployment layer.

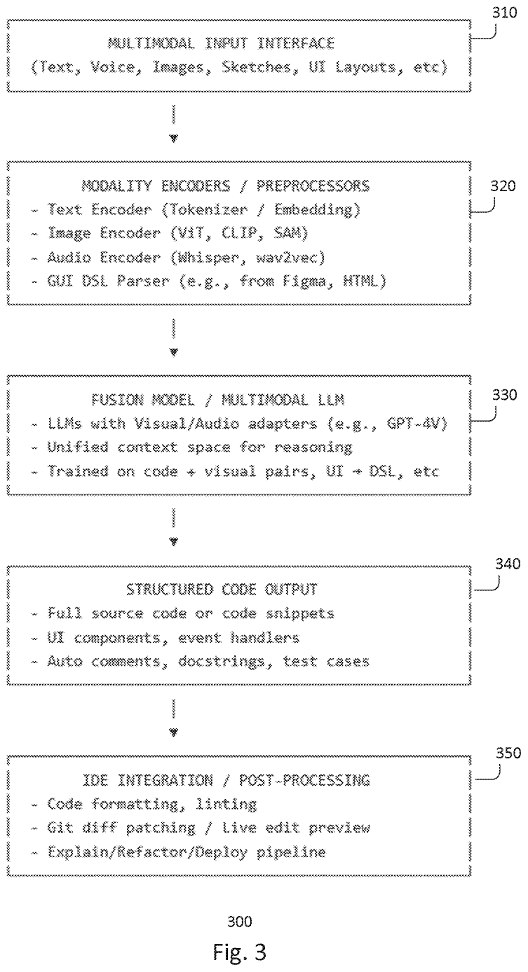

FIG. 3 shows an embodiment of a simplified multi-model input code engine 300 configured to generate structured code outputs from one or more different types of input data. The engine includes a multimodal input interface 310, a modality encoders/preprocessors layer 320, a fusion model/multimodal large learning model (LLM) layer 330, a structured code output layer 340, and an IDE integration and post-processing layer 350. Directional arrows between the components represent data flow and transformation of inputs through the layers of the engine.

In one embodiment, the multimodal input interface is configured to receive a plurality of input types such as text, voice, images, sketches, and user interface (UI) layouts.

The modality encoders/preprocessors layer is configured to convert each input into a machine-interpretable representation. For example the modality encoders/preprocessors layer includes a text encoder configured to tokenize and embed natural language input, an image encoder configured to process visual inputs using vision-based models, an audio encoder configured to transcribe or represent voice inputs, and a graphical user interface (GUI) or domain-specific language (DSL) parser configured to extract structured elements from UI layouts and convert the extracted elements into machine-interpretable representation.

The machine-interpretable representations generated by the modality encoders/preprocessors layer are provided to the fusion model/multimodal (LLM) layer to integrate the representations into a unified representation.

The structured code output layer is configured to generate one or more executable code artifacts based on the unified representation. For example, the executable code artifacts include source code, configuration files or user interface components corresponding to the input types.

The IDE integration/post-processing layer is configured to integrate the generated code artifacts into an integrated development environment. In one embodiment, the IDE integration and post-processing layer performs one or more post-processing operations including code formatting, linting, and git diff patching. The layer may further support live previewing, explanation, refactoring, and deployment pipeline operations for the generated code artifacts.

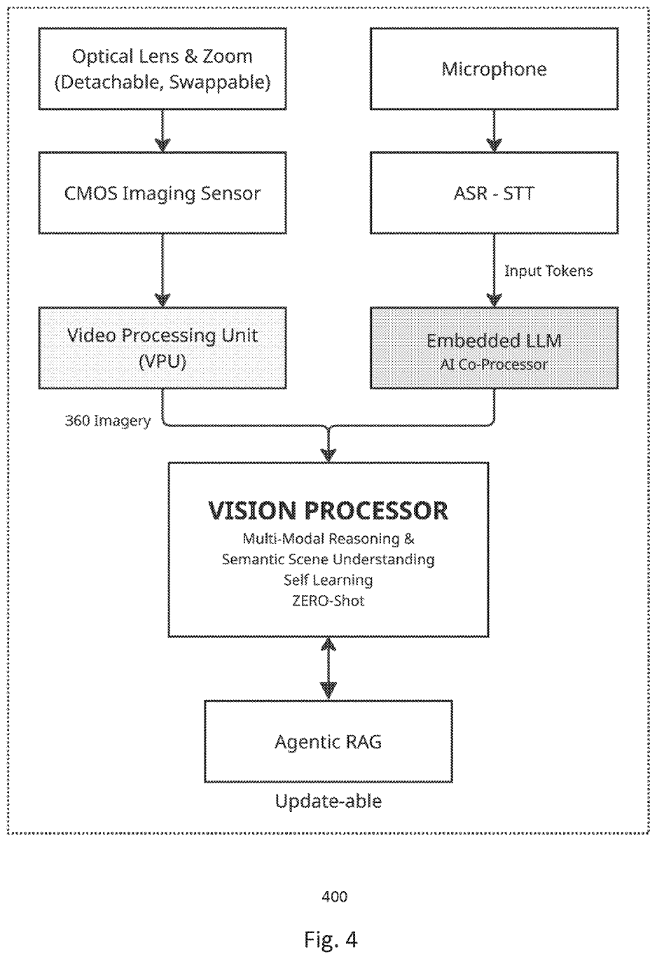

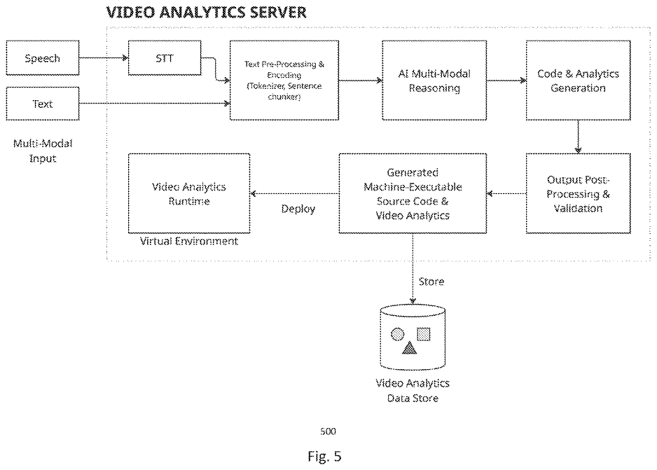

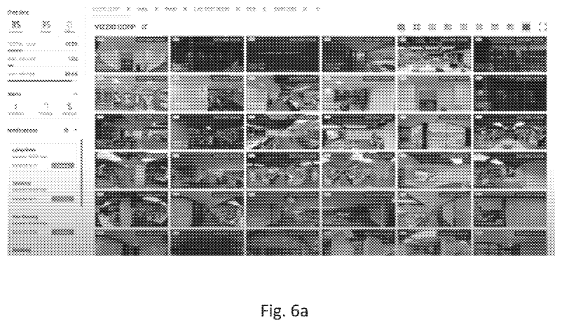

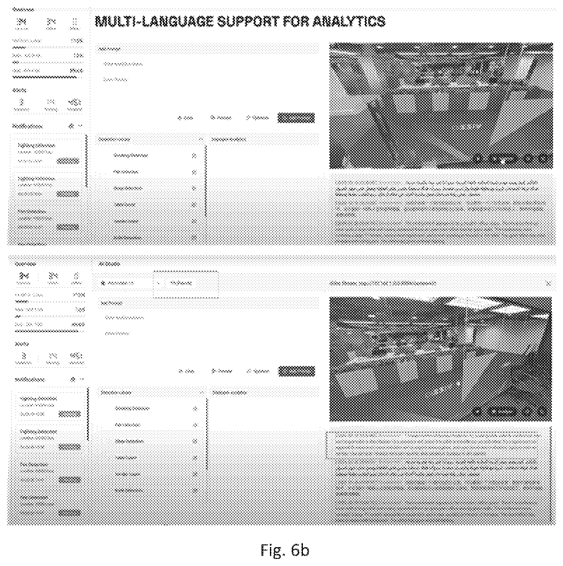

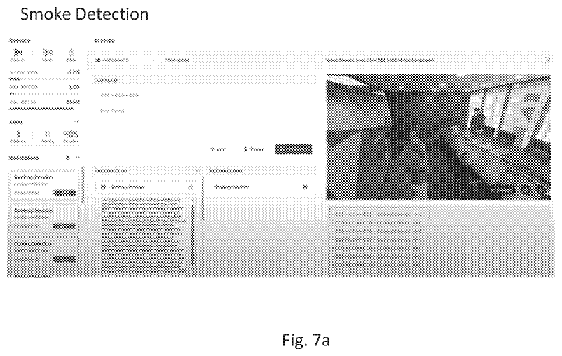

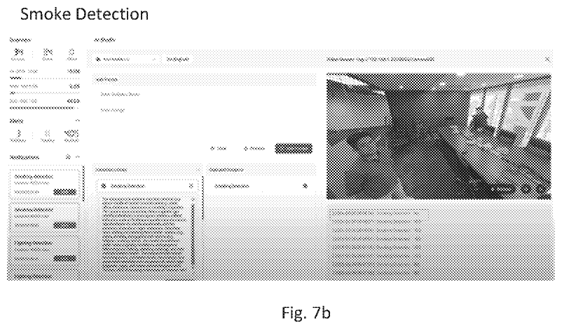

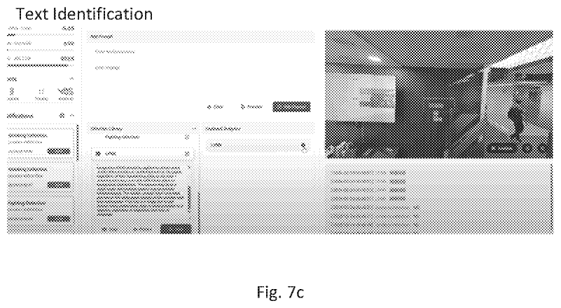

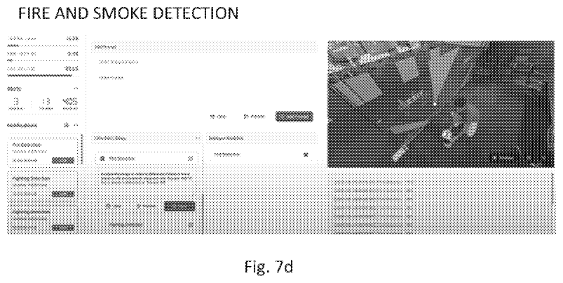

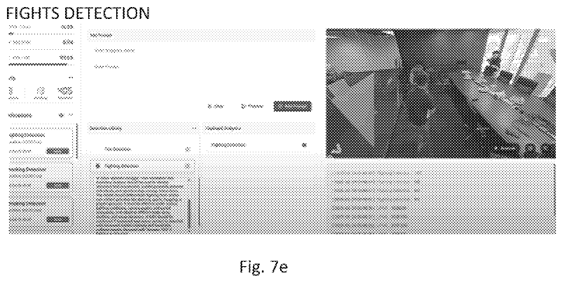

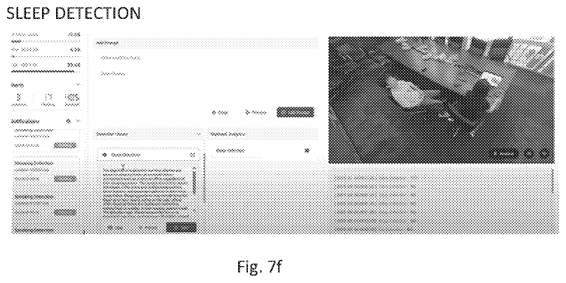

FIG. 4 shows a simplified block diagram of an embodiment of a digital intelligence system 400 for a sensor and/or camera. The system integrates multiple data streams from a camera and/or sensor to create a cohesive, context-aware, and intelligence-driven security and surveillance system. Although video remains the primary input for most surveillance tasks, the inclusion of audio signals and contextual data sources, such as textual meta-information or sensor logs, broadens the comprehension capabilities of the system.

The system is configured to capture a variety of inputs in real-time or near real-time. Visual data is captured through the Optical Lens & Zoom assembly, which is detachable and swappable, and is converted to digital signals by the CMOS Imaging Sensor. The resulting video signals are processed by the Video Processing Unit (VPU), which is configured to generate 360-degree imagery and perform preliminary image enhancement or video processing operations.

Audio data is captured by the Microphone and provided to the ASR-STT (Automatic Speech Recognition-Speech-to-Text) module, which converts the audio signals into textual input tokens. These input tokens are then processed by the Embedded LLM AI Co-Processor, enabling the system to interpret speech, detect acoustic events, and generate semantic embeddings for further reasoning. Contextual information, such as textual metadata or other sensor readings (e.g., temperature or radar-based motion detection), can also be incorporated into the processing pipeline.

The outputs from the Video Processing Unit and the Embedded LLM AI Co-Processor are provided to the VISION PROCESSOR, which functions as the intelligent processing module of the system. The vision processor performs multi-modal reasoning and semantic scene understanding by integrating the visual, audio, and textual features. It is configured to identify objects, people, vehicles, and their interactions, as well as to infer higher-order contextual relationships within the observed scene. The system is capable of zero-shot reasoning and self-learning, allowing it to recognize previously unseen scenarios without task-specific retraining.

The vision processor is further coupled to an Agentic RAG (Retrieval-Augmented Generation) module, which is update-able and enables the system to retrieve external or locally stored knowledge to enhance reasoning. This configuration allows the system to continuously improve its understanding of the environment and adapt its decision-making over time. The interaction between the vision processor and the agentic RAG module supports bidirectional knowledge flow, where contextual information can be retrieved to aid reasoning and newly inferred insights can be stored for future use.

The system can be deployed in a variety of scenarios including security and surveillance for real-time threat detection, retail or commercial spaces for monitoring customer engagement, public safety for crowd management or emergency response, and industrial environments for detecting operational anomalies or safety violations.

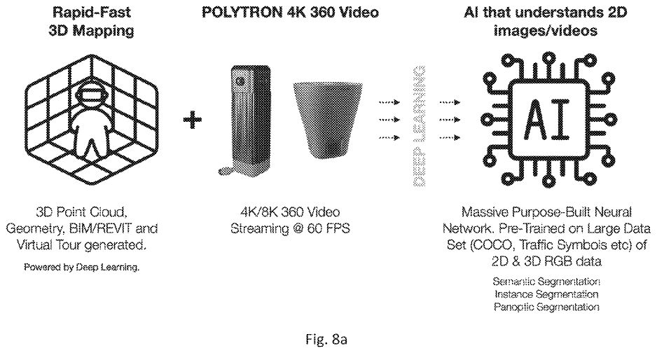

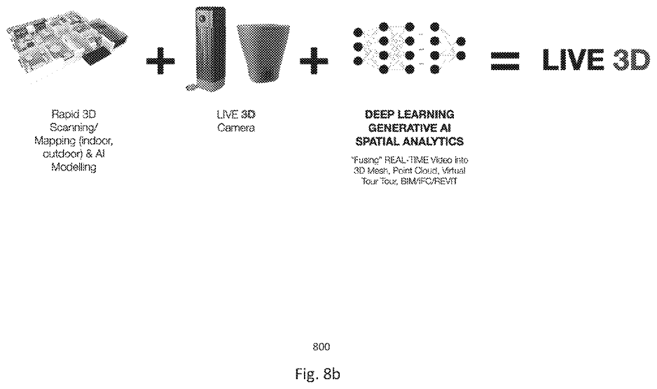

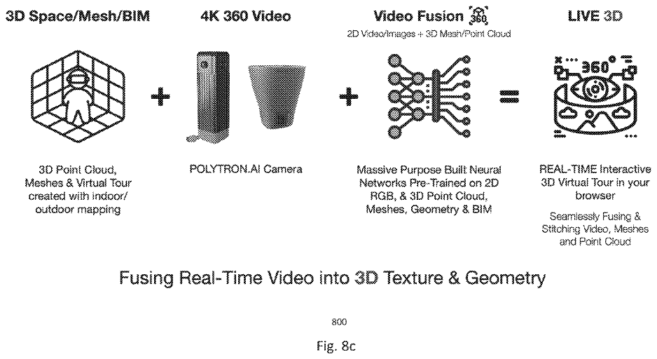

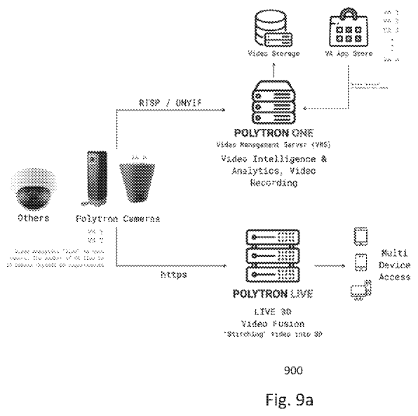

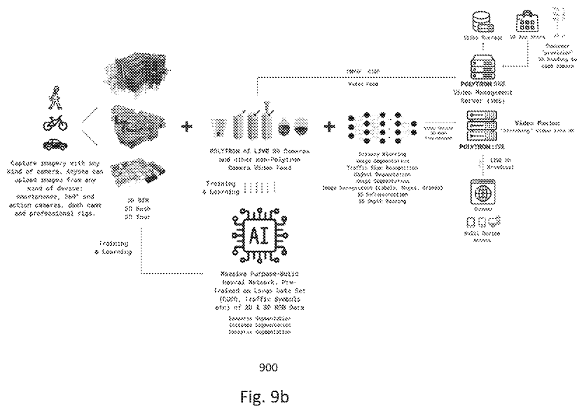

FIGS. 8a-8c show an embodiment of a live 3D mapping and analytics system 800. The system includes rapid 3D scanning and mapping technologies (including indoor and outdoor modeling with AI), one or more live 3D cameras that capture high-resolution video feeds and integrate them into a spatial 3D geometry at the EDGE, creating a dynamic LIVE virtual environment where real-time monitoring occurs, and deep learning-based generative AI spatial analytics to fuse the captured real-time video streams with spatial 3D representations of the environment, including 3D point clouds, 3D meshes, and building information models (BIM), generated via indoor and outdoor mapping of the environment to produce a live, real-time 3D output that supports immersive, interactive, and 360-degree visualization on a browser. The system integrates videos streams into spatial 3D geometries, creating an immersive, interactive, and real-time visualization of the environment, supporting applications such as monitoring, analysis, and anomaly detection. The system provides a continuous, real-time, 360-degree representation that reflects changes in physical space as they occur.

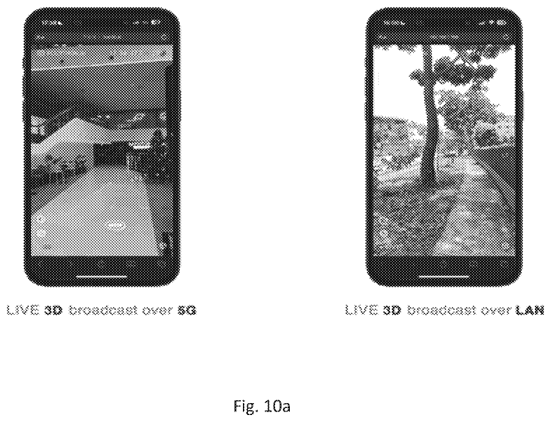

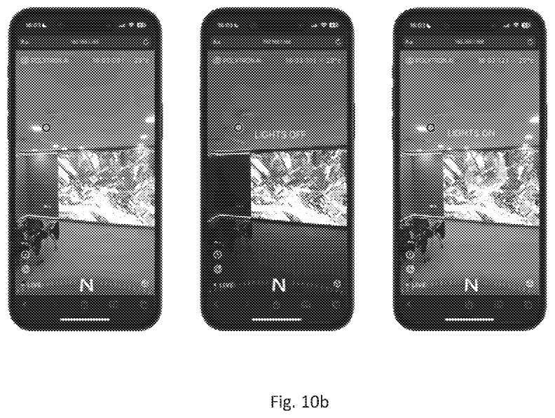

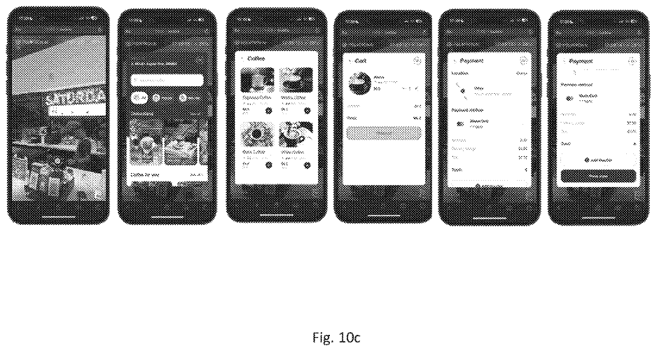

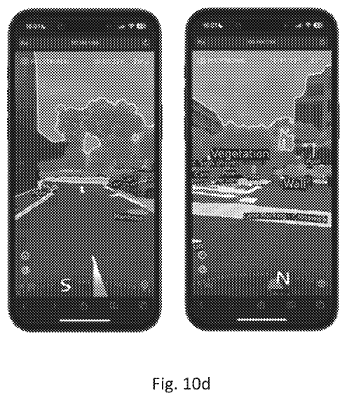

FIGS. 10a-10d show different examples of general applications of the live 3D mapping and analytics system on a mobile device. For example, FIG. 10a shows a user navigating a 3D scene with a real-time video feed and real-time video analytics, providing a real-time digital replica of a real-world environment. FIG. 10b shows real-time control of the environment, such as turning lights on and off via interactive toggle controls and FIG. 10c shows e-commerce functionality enabled within the 3D environment such as purchasing a cup of coffee using the interactive toggle controls. FIG. 10d shows real-time detection and segmentation, where the system identifies and labels elements within the scene, including vegetation, walls, lane markings, crosswalks, poles, signs, and pedestrians. Other types of devices such as tablets, computers, AR and VR may also be used.

Traditional surveillance systems require significant human intervention, from controlling camera movements to analysing video feeds for security threats. The reliance on human operation not only increases labour costs but also introduces the risk of human error and inefficiencies. This engine autonomously navigates the 3D space, planning and adjusting patrol routes based on predefined algorithms and learning from environmental interactions.

Human security personnel conducting ground patrols typically exhibit behaviours characterised by adaptability and responsiveness to their surroundings. They might alter their patrol routes based on observed anomalies or changes in environmental conditions. To mimic such human-like adaptability in an AI system, the AI route-navigation engine is designed to dynamically select its path through the virtual environment. This is achieved using algorithms capable of real-time decision-making and environmental interaction, akin to human cognitive processes.

The path navigation of this AI system is not random in the sense of being purely stochastic or arbitrary, but rather it is unpredictably variable, guided by principles of randomness integrated with strategic decision-making. This is achieved through the use of algorithms such as Monte Carlo tree search (MCTS) or Reinforcement Learning (RL) models that allow the AI to explore and evaluate different paths based on probabilistic outcomes and past learning. This ensures that the AI's patrolling pattern is not easily predictable and can adapt to new or changing scenarios, much like a human would.

The AI employs a combination of “virtual” sensors and data inputs integrated into the 3D environment that simulate the sensory inputs a human would use to perceive their surroundings. The AI analyses this data to make decisions about where to patrol next. Advanced machine learning models, particularly those trained on reinforcement learning principles, enable the AI to learn from each patrol iteration, enhancing its decision-making processes over time. The AI's ability to integrate and interpret complex data inputs in real time allows it to respond to dynamic environmental variables and threats just as effectively as human patrollers would.

By eliminating the need for manual controls, the AI system enhances operational efficiency and reliability. Manual inputs, such as mouse clicks or joystick manipulations, are replaced with ever-learning decision frameworks that continuously assess and react to the “virtual environment”. This not only reduces the likelihood of human error but also enables a continuous 24/7 patrol capability without fatigue, a limitation often faced by human operators. The system incorporates human-like flexibility and adaptability into its operational protocols, leveraging advanced AI methodologies and photorealistic 3D scenes to navigate and secure a virtual space effectively.

The real-time video analysis analyses incoming video streams to detect a range of anomalies, including unauthorised entry, safety hazards (e.g., fire, smoke), or compliance violations (e.g., absence of protective gear) and other potential risks. The number of video intelligence analytics bind to a camera depends on the use case and the capacity of the edge processing servers. It uses advanced detection algorithms capable of recognising even unfamiliar objects or situations through a zero-shot generalisation technique. Detected anomalies and security alerts are communicated in real-time to the command centers, allowing for swift response and intervention.

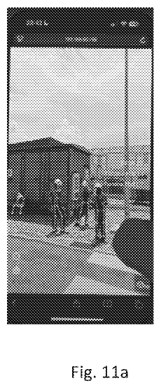

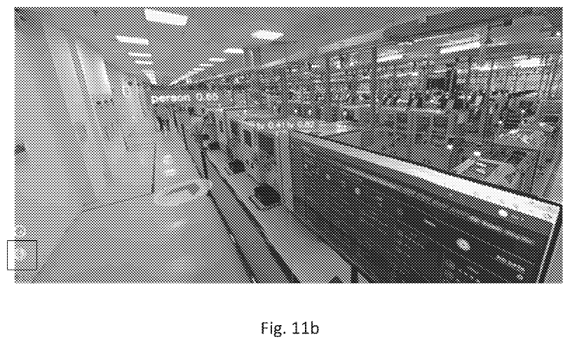

As shown in FIG. 11a, the system also includes a Human Pose Estimation (HPE) module. The mobile device interface displays real-time detection of individuals, with the Human Pose Estimation (HPE) module applied to identify and classify human postures. The system uses colored lines to form a skeletal structure representing the body joints, enabling the detection of various states, such as standing or sitting, based on the relative positioning of the joints. The system with its continuous AI-driven real-time monitoring can detect and respond to anomalies faster and more reliably than human operators.

As shown in FIG. 11b, for security patrol and surveillance, the system analyzes detected objects and provides a conclusion regarding the identification or classification of the item, along with the associated confidence level of the detection result. When the toggle in the square box is activated, the route planning process is fully automated and controlled by the AI system, with no manual input or mouse clicks required from the user.

The inventive concept of the present disclosure may be embodied in other specific forms without departing from the spirit or essential characteristics thereof. The foregoing embodiments, therefore, are to be considered in all respects illustrative rather than limiting the invention described herein.

What is claimed is:

1. A system for implementing digital intelligence in a camera or in a server, using multi-modal data, comprising:
a camera sensor configured to capture video data of a monitored environment;
at least one additional sensor selected from a group consisting of an audio sensor and a contextual data sensor; and
a processor disposed in or proximate to the camera, the processor comprising instructions executable to:
receive the video data from the camera sensor;
receive input from said at least one additional sensor;
analyze the video data in conjunction with the additional sensor data using an AI inference model capable of correlating disparate modalities; and
generate an output indicative of semantic understanding of at least one event in the monitored environment.
